(19) United States
(12) Patent Application Publication
(10) Pub. No.: US 2026/0308013 A1
(43) Pub. Date: Oct. 8, 2026

(54) A METHOD FOR SYNTHESIS OF CATHODE MATERIALS FROM BLACK MASS

(71) Applicant: University of Kentucky Research Foundation, Lexington, KY (US)

(72) Inventors: Jian Shi, Lexington, KY (US); Yuxuan Zhang, Lexington, KY (US); Ning Wei, Lexington, KY (US); Qing Shao, Lexington, KY (US); Xin Gao, Lexington, KY (US)

(73) Assignee: University of Kentucky Research Foundation, Lexington, KY (US)

(21) Appl. No.: 19/179,478

(22) Filed: Apr. 15, 2025

Related U.S. Application Data
(60) Provisional application No. 63/635,827, filed on Apr. 18, 2024.

(51) Int. Cl. C01G 53/502; H01M 10/54

(52) U.S. Cl. CPC C01G 53/502; H01M 10/54

(57) ABSTRACT

A method for directly synthesizing nickel-manganese-cobalt (NMC) electrode materials from black mass, includes steps of: leaching the black mass with a hydrophobic deep eutectic solvent to extract critical metals, including lithium, cobalt, nickel and manganese, and generate a pregnant hydrophobic deep eutectic solvent, adding a precipitant to the pregnant hydrophobic deep eutectic solvent to precipitate salts of the NMC electrode materials from a lithium-enriched hydrophobic deep eutectic solvent, adjusting metal ratios of nickel, manganese and cobalt in the precipitated salts of the NMC electrode materials to a target metal ratio for cathode synthesis to generate a precursor formulation and synthesizing a target cathode material from the precursor formulation.

### RELATED APPLICATIONS

This document claims the benefit of U.S. Provisional Patent Application Ser. No. 63/635,827, filed on Apr. 18, 2024, the full disclosure of which is incorporated herein by reference.

### STATEMENT REGARDING FEDERALLY SPONSORED RESEARCH OR DEVELOPMENT

This invention was made with government support under Grant No. DE-SC0025346 awarded by the Department of Energy. The government has certain rights in the invention.

### TECHNICAL FIELD

This document relates generally to methods for the synthesis of cathode materials from black mass.

### BACKGROUND

The extensive usage of lithium-ion batteries (LIBs) in electronic devices and electric vehicles (EV) will produce an increasing amount of waste from dead batteries in the future. Among various parts, the cathode material is critical because it contains metals that are valuable and limited in quantity in nature. As a consequence, proper and efficient methods are needed to extract and recover these metal elements from the cathode materials of spent LIBs.

Toward this end, this document relates to new and improved methods for the recovery of cathode materials, including nickel-manganese-cobalt (NMC), by leaching. This may be accomplished using novel hydrophobic binary/ternary/quaternary deep eutectic solvents (hDESs) for effective metal extraction. The methods then call for adjustment of the metal ratios, followed by direct conversion of those recovered cathode materials into high performance cathode materials, reducing the need to purchase virgin metal salts and enabling closed-loop battery manufacturing.

### SUMMARY

In accordance with the purposes and benefits set forth herein, a method for synthesizing nickel-manganese-cobalt (NMC) electrode materials from black mass, comprises, consists of or consists essentially of: (a) leaching the black mass with a leaching agent, such as a hydrophobic deep eutectic solvent, to extract critical metals, including lithium, cobalt, nickel and manganese, and generate a pregnant leaching agent/hydrophobic deep eutectic solvent, (b) adding a precipitant to the pregnant leaching agent/hydrophobic deep eutectic solvent to precipitate salts of the NMC electrode materials from a lithium-enriched leaching agent/hydrophobic deep eutectic solvent, (c) adjusting metal ratios of nickel, manganese and cobalt in the precipitated salts of the NMC electrode materials to a target metal ratio for cathode synthesis to generate a precursor formulation, and (d) synthesizing a target cathode material from the precursor formulation.

In at least some embodiments, the adjusting of metal ratios includes mixing the precipitated salts with at least one supplemental metal salt material selected from a group consisting of a nickel salt, a manganese salt, a cobalt salt and combinations thereof to provide the target metal ratio for cathode synthesis. In some embodiments, the adjusting of metal ratios further includes adding lithium salt to the precipitated salts in a 0.1 to 20 weight percent excess to compensate for potential losses during subsequent calcination.

In at least some of the many possible embodiments, the method further includes recovering lithium salts from the lithium-enriched leaching agent/hydrophobic deep eutectic solvent and using at least some of the recovered lithium salts to adjust the metal ratios.

In at least some embodiments, the synthesizing of the target cathode material includes subjecting the precursor formulation to thermal treatment to form the target cathode material. The thermal treatment may comprise calcining the precursor formulation. The calcining may include heating to a temperature of between 700° C. to 900° C. for 8 to 14 hours in air or under controlled oxygen flow. The controlled oxygen flow may comprise maintaining the gas flow at 10-40 L/min per kilogram of precursor formulation.

The method may also include obtaining uniform cathode particles from the target cathode material by performing one or more of the following:
(a) cooling the target cathode material following the thermal treatment;
(b) grinding the target cathode material to a desired particle size; and
(c) sieving the ground cathode material to obtain the uniform cathode particles.

The method may include recovering the leaching agent/hydrophobic deep eutectic solvent following the recovering of the lithium salts from the lithium-enriched hydrophobic deep eutectic solvent and recycling the recovered hydrophobic deep eutectic solvent for future leaching of additional black mass.

The synthesizing of the target cathode material may include subjecting the precursor formulation to thermal treatment to form the target cathode material. The thermal treatment may include calcining the precursor formulation. The calcining may comprise heating the precursor formulation to a temperature of between 700° C. to 900° C. for 8 to 14 hours in air or under controlled oxygen flow. The controlled oxygen flow may include maintaining the gas flow at 10-40 L/min per kilogram of precursor formulation.

In some embodiments, the method includes obtaining uniform cathode particles from the target cathode material by performing one or more of the following:
(a) cooling the target cathode material following the thermal treatment;
(b) grinding the target cathode material to a desired particle size; and
(c) sieving the ground cathode material to obtain the uniform cathode particles.

In at least some embodiments, the leaching of the black mass includes mixing the leaching agent/hydrophobic deep eutectic solvent with the black mass at a mass ratio of leaching agent/hydrophobic deep eutectic solvent to black mass of from 5:1 to 50:1 to create a leaching agent/hydrophobic deep eutectic solvent and black mass mixture. In some embodiments, the leaching of the black mass includes heating the leaching agent/hydrophobic deep eutectic solvent and black mass mixture to a temperature of between 80° C. and 140° C. for 2 to 24 hours with continuous or intermittent stirring.

In at least some embodiments, the precipitant is selected from a group of materials consisting of oxalic acid, oxalic salts, sodium oxalate, potassium oxalate ammonium oxalate, sodium hydroxide, ammonium hydroxide, potassium hydroxide and combinations thereof. In some embodiments, the method includes providing a precipitant solution at a volume ratio of pregnant leaching agent/hydrophobic deep eutectic solvent to precipitant solution of between 0.1:1 and 10:1. The precipitation of the salts of the NMC electrode materials may be performed at room temperature with mixing.

In accordance with an additional aspect, a method for synthesizing electrode materials from black mass, comprises, consists of or consists essentially of: (a) leaching the black mass with a hydrophobic deep eutectic solvent to extract critical metals for electrode construction and generate a pregnant hydrophobic deep eutectic solvent, (b) adding a precipitant to the pregnant hydrophobic deep eutectic solvent to precipitate salts of the electrode materials from a lithium-enriched hydrophobic deep eutectic solvent, (c) adjusting metal ratios in the precipitated salts of the electrode materials to a target metal ratio for cathode synthesis to generate a precursor formulation, and (d) synthesizing a target cathode material from the precursor formulation.

The method provides a number of benefits and advantages.
(a) The use of deep eutectic solvents avoids the generation of hazardous acid waste streams common in traditional hydrometallurgical recycling. The process significantly reduces the use of strong acids or bases, making it safer and greener.
(b) The stepwise precipitation method allows for selective separation of valuable metals, improving the purity of recovered materials and reducing the complexity of downstream processing.
(c) Reclaiming and reusing deep eutectic solvents not only lowers operational costs but also minimizes environmental impact, supporting circular economy principles.
(d) Operating temperatures for leaching are moderate (80-140° C.), which reduces energy input compared to pyrometallurgical routes. Additionally, deep eutectic solvent systems are generally non-flammable and non-volatile, enhancing process safety.
(e) By tailoring the metal ratios during recombination, the process outputs can be directly converted into high-performance cathode materials, reducing the need for purchasing virgin metal salts and enabling closed-loop battery manufacturing.
(f) The integrated design of leaching, selective precipitation, lithium recovery, deep eutectic solvent recycling, and cathode material synthesis minimizes the need for external reagents, reduces waste management requirements, and eliminates intermediate purification steps, resulting in a significant reduction in overall process costs.
(g) The process can be easily adapted to different black mass compositions and scaled up using conventional chemical equipment, making it suitable for both laboratory and industrial-scale operations.

In the following description, there is shown and described several different embodiments of a new and improved method for the direct synthesis of cathode materials from black mass. As it should be realized, the method is capable of other, different embodiments and its several details are capable of modification in various, obvious aspects all without departing from the method as set forth and described in the following claims. Accordingly, the drawings and descriptions should be regarded as illustrative in nature and not as restrictive.

### BRIEF DESCRIPTION OF THE DRAWING FIGURES

FIG. 1 is a schematic representation of the new and improved method for synthesizing cathode materials, more particularly, nickel-manganese-cobalt (NMC) electrode materials, from black mass using a leaching agent, preferably hydrophobic deep eutectic solvents (hDESs), as a leaching solution.

### DETAILED DESCRIPTION

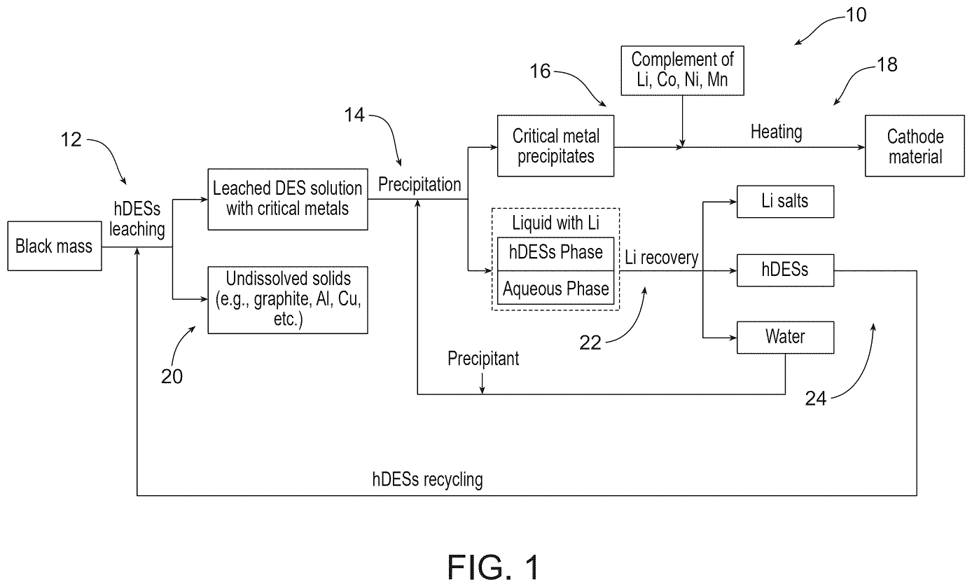

As shown in FIG. 1, the new and improved method 10 for synthesizing nickel-manganese-cobalt (NMC) electrode materials from black mass may be broadly described as including the steps of: (a) leaching the black mass with a leaching agent (e.g. hydrophobic deep eutectic solvent) to extract critical metals, including lithium, cobalt, nickel and manganese, and generate a pregnant leaching agent 12, (b) adding a precipitant to the pregnant leaching agent to precipitate salts of the NMC electrode materials from a lithium-enriched leaching agent 14, (c) adjusting metal ratios of nickel, manganese and cobalt in the precipitated salts of the NMC electrode materials to a target metal ratio for cathode synthesis to generate a precursor formulation 16, and (d) synthesizing a target cathode material from the precursor formulation 18.

For purposes of this document, the term “black mass” refers to the mixture of metals and other materials that form when lithium-ion batteries are broken down, by shredding or other means, during the recycling process. Black mass includes various metals, such as lithium, nickel, manganese and cobalt, that are essential to new lithium-ion battery production. The exact chemical composition of the black mass will vary depending upon the type and make of battery being recycled.

The leaching agent used in the method is preferably a hydrophobic deep eutectic solvent. For purposes of this document, the term “hydrophobic deep eutectic solvent” refers to a combination of two or more of the following: (a) a hydrophobic component, (b) an acidic component, and (c) a reducing agent. In one particularly useful embodiment, the solvent includes the hydrophobic component, the acidic component and the reducing agent. For further clarification, some compounds can play two roles at the same time. For example, in the case of a binary deep eutectic solvent between (a) menthol and (b) ethylene glycol or glycerol, menthol can act as both a hydrophobic and acidic component when mixed with ethylene glycol or glycerol. The lignin-derived hydrophobic deep eutectic solvents represent a new class of solvents that can selectively extract metals from the spent batteries. This new technology is circular, sustainable, and green and, therefore, can potentially replace the conventional hydrometallurgical process.

For the purposes of this document, the term “hydrophobic component” refers to compounds that are of intermediate and high molecular weight (i.e. a molecular weight greater than 180 Dalton) or are long chain hydrocarbons (i.e. hydrocarbons having a length of greater than six (6) carbon atoms with foreign atoms (O, N, P, S) or are cyclic hydrocarbons (i.e. hydrocarbons having a length of greater than five (5) carbon atoms with foreign atoms (O, N, P, S) that are either insoluble or sparingly soluble in water or if present in the solvent as a component, the solvent becomes insoluble in the water. Typically, the hydrophobic components are high molecular weight compounds having high melting (greater than 20° C.) and boiling points (greater than 160° C.) and are nonpolar in nature. In many applications, the hydrophobic component is lignin derived. This includes high molecular weight alkyl phenols, high molecular weight methoxy phenols, and high molecular weight ketones and alcohols with an aliphatic and aromatic ring.

Lignin-derived hydrophobic components include, but are not necessarily limited to menthol, thymol, 2,2-dimethoxypropane (DMP), vanillin, 4-hydroxybenzyl alcohol, phenol and its derivatives, guaiacol, cresol, syringol, apocynin, and syringaldehyde. Other useful hydrophobic components include, but are not necessarily limited to, napthol and lidocaine.

The acidic component includes organic compounds that can donate a hydrogen bond (acts as a Lewis acid) to a hydrogen bond acceptor. It covers any compounds with one or more carboxylic acid functional groups as well as the compounds without carboxylic acid functional groups but acts as a Lewis acid in the deep eutectic solvent system. Acidic components include, but are not necessarily limited to, acids including one or more carboxylic functional groups, decanoic acid, formic acid, citric acid, lactic acid, dodecanoic acid, succinic acid, ascorbic acid, malic acid, oxalic acid, malonic acid, adipic acid, benzoic acid and mixtures thereof.

Reducing agents useful in the solvent include, those that are solid or liquid at room temperature and capable of reducing metal ions during leaching by providing electrons. Such reducing agents include, but are not necessarily limited to aliphatic and aromatic alcohols with one or more than one-OH functional group, amides, and amino acids. Such reducing agents include, but are not limited to, ethylene glycol, glycerol, ascorbic acid, malic acid, glucose, urea, thiourea, acetimide, benzamide, glycine, alanine, sorbitol and mixtures thereof.

Various combinations of these components (i.e., Thymol/glycerol, DMP/glycerol, Decanoic acid/glycerol, Menthol/decanoic acid/ethylene glycol, thymol/decanoic acid/ethylene glycol, etc.) at different ratios (i.e., 1:1, 1:2, 1:1:1, 1:1:2, 1:2:1, 1:2:2, 1:1:1:1, 1:2:2:1, 1:1:2:2 etc.) are used to prepare the new solvents. More than one (a) hydrophobic component, (b) acidic component, and/or (c) reducing agent may be used in the hydrophobic deep eutectic solvent. Thus, various combinations of these components (i.e., Thymol/glycerol, DMP/glycerol, Decanoic acid/glycerol, Menthol/decanoic acid/ethylene glycol, thymol/decanoic acid/ethylene glycol, etc.) at different ratios (i.e., 1:1, 1:2, 1:1:1, 1:1:2, 1:2:1, 1:2:2, 1:1:1:1, 1:2:2:1, 1:1:2:2 etc.) are used to prepare the new deep eutectic solvents.

Methods for making the hydrophobic deep eutectic solvents are described in detail in document WO 2024/059051, filed on Sep. 12, 2023, the full disclosure of which is incorporated herein by reference.

Tables I and II below include some examples of the new deep eutectic solvents useful for the recovery of critical metals such as lithium, cobalt, nickel, and manganese from spent, end-of-life lithium-ion batteries.

TABLE I
Any combination (binary, ternary, or quaternary) of these
compounds can be mixed to prepare deep eutectic solvents.

| | Hydrogen Bond | Hydrogen Bond | |
|---|---|---|---|
| | Acceptors (HBA) | Donors (HBD) | |
| | (Hydrophobic | (Acidic | HBA/HBD |
| DES | component) | component) | (Reducing agent) |
| | Menthol | Decanoic acid | Ethylene glycol (EG) |
| | | Decanoic acid | Thymol |
| | | Decanoic acid | DMP |
| | | Thymol | Ethylene glycol (EG) |
| | | Succinic acid | Ethylene glycol (EG) |
| | | Formic acid | Ethylene glycol (EG) |
| | Thymol | Decanoic acid | Ethylene glycol (EG) |
| | | Decanoic acid | DMP |
| | | Formic acid | Ethylene glycol (EG) |
| | | Ethylene glycol (EG) | DMP |
| | | Succinic acid | DMP |

Note:
*HBA = hydrogen bond acceptors and HBD = hydrogen bond donor

TABLE II
Any combination of the components (as a binary, ternary,
or quaternary mixture) mentioned in the table can
be used to prepare deep eutectic solvents.

| | Hydrogen Bond | Hydrogen Bond | |
|---|---|---|---|
| | Acceptors (HBA) | Donors (HBD) | |
| | (Hydrophobic | (Acidic | HBA/HBD |
| DES | component) | component) | (Reducing agent) |
| | Menthol | Decanoic acid | Formic acid |
| | | Decanoic acid | Lactic acid (LA) |
| | | Decanoic acid | Citric acid |
| | | Formic acid | Thymol |
| | | Formic acid | DMP |
| | | Formic acid | Lactic acid (LA) |
| | | Citric acid | Ethylene glycol (EG) |
| | | Citric acid | Thymol |
| | | Citric acid | DMP |
| | | Citric acid | Lactic acid (LA) |
| | | Lactic acid | Ethylene glycol |
| | | Butyric acid | Glycerol |
| | | Valeric acid | Glycerol |
| | | Decanoic acid | Glycerol |
| | | Thymol | Glycerol |
| | Thymol | Decanoic acid | Formic acid |
| | | Decanoic acid | Lactic acid (LA) |
| | | Decanoic acid | Citric acid |
| | | Formic acid | |
| | | Formic acid | DMP |
| | | Formic acid | Lactic acid (LA) |
| | | Citric acid | Ethylene glycol (EG) |
| | | Citric acid | Thymol |
| | | Citric acid | DMP |
| | | Citric acid | Lactic acid (LA) |
| | | Decanoic acid | Formic acid |
| | | Butyric acid | Glycerol |
| | | Valeric acid | Glycerol |
| | | Decanoic acid | Glycerol |

The leaching of the black mass includes mixing the hydrophobic deep eutectic solvent with the black mass at a mass ratio of hydrophobic deep eutectic solvent to black mass of from 5:1 to 50:1 (7.5:1 to 45:1, 10:1 to 40:1, 15:1 to 35:1, 20:1 to 30:1) to create a hydrophobic deep eutectic solvent and black mass mixture. The black mass mixture may be heated to a temperature of between 80° C. and 140° C. for 2 to 24 hours with continuous or intermittent stirring in order to promote efficient leaching of desired materials from the black mass. After leaching, the mixture is subjected to centrifugation to separate undissolved solids from the resulting pregnant hydrophobic deep eutectic solvent containing dissolved lithium and at least one of nickel, manganese and cobalt 20.

A precipitant is then added to the pregnant hydrophobic deep eutectic solvent in order to precipitate salts of nickel, manganese and cobalt (NMC salts) from what is now a lithium-enriched hydrophobic deep eutectic solvent 14. The precipitant may be selected from a group of materials adapted to form salts of nickel, manganese and cobalt. Such precipitants may be selected from a group including or consisting of (a) oxalic acid, (b) oxalic salts such as sodium oxalate, potassium oxalate ammonium oxalate, etc, (c) sodium hydroxide, (d) ammonium hydroxide, (e) potassium hydroxide and (f) combinations thereof.

The concentration of the aqueous precipitant solution may range from 0.5 M to 5 M, 0.75 M to 4.75 M, 1M to 4 M, 1.5 M to 3.5 M, 2 M to 3M or 2M to 5M. The volume ratio of pregnant hydrophobic deep eutectic solvent to precipitant solution is between 0.1:1 to 10:1, 0.5:1 to 9.5:1, 1:1 to 9:1, 2:1 to 8:1, 3:1 to 7:1, 4:1 to 6:1. The precipitation may be conducted at room temperature with only gentle mixing, such rotating at 60 rpm for 1 to 24 hours. The resulting critical metal precipitates (e.g. salts of nickel, manganese and cobalt) may be separated from the remaining lithium-enriched deep eutectic solvent by centrifugation at greater than 2,500 rpm, such as between 2,500 rpm and 4,000 rpm. Alternatively, vacuum filtration may be used for this purpose.

The remaining lithium-enriched deep eutectic solvent contains two phases: the deep eutectic solvent phase and the aqueous phase. Based upon the properties of the deep eutectic solvent, there are two scenarios after separating these two phases. In the first scenario, the lithium is enriched in the deep eutectic solvent phase. More specifically, an anti-solvent is added to the lithium-enriched deep eutectic solvent in order to precipitate lithium salt. Anti-solvents useful for this purpose include, for example, water, ethanol, acetone, methanol and mixtures thereof. The anti-solvent is added at a volume ratio adapted to cause lithium salts to precipitate. For example, ethanol may be added in a volume ratio (V/V) of from 0.5:1 to 3:1. After lithium salt precipitation, the solid and liquid phases may be separated by centrifugation at greater than 2,500 rpm. The recovered solid lithium salts may then be dried in an oven at, for example, 105 to 110° C. in order to remove any residual solvent.

If water is used to extract the lithium salts from deep eutectic solvent phase, the lithium rich aqueous solution can be subjected to evaporation to crystalize the lithium salts or subjected to a membrane separation process (reverse osmosis, nanofiltration, and/or pervaporation) to separate the lithium salts.

Alternatively, an aqueous solution of sodium carbonate (0.5M to 5M) is added to the lithium-enriched deep eutectic solvent, at a volume ratio (V/V) of 0.1:1 to 10:1, in order to precipitate lithium salt. The lithium carbonate, that forms and precipitates from the deep eutectic solvent, may then be separated via centrifugation at greater than 2,500 rpm and then dried at, for example 105-110° C. in an oven.

Other methods of lithium recovery from the lithium-enriched deep eutectic solvent include, but are not necessarily limited to, electrochemical deposition, evaporation and adsorption. In electrochemical deposition, lithium is deposited onto an electrode under controlled voltage and current in a deep eutectic solvent-compatible electrochemical cell. The deep eutectic solvent may then be directly recycled after lithium deposition.

In evaporation, the deep eutectic solvent is evaporated at about 160-200° C. under vacuum, leaving behind lithium salt or hydroxide. The vapor may then be collected and condensed to regenerate the deep eutectic solvent.

In adsorption, the lithium is adsorbed onto an ion-exchange resin or selective adsorbent, followed by desorption and recovery in a manner known in the art. The deep eutectic solvent may then be directly recycled after lithium adsorption.

Under the second scenario, the deep eutectic solvent is directly recycled after separating the aqueous solution. The lithium remaining in the aqueous solution is recovered by one of the following methods.
(a) Sodium Carbonate Precipitation
   (i) sodium carbonate is added to the lithium-containing aqueous solution at a ratio of, for example, 0.1:1 to 10:1; and
   (ii) the lithium carbonate formed is separated via centrifugation at greater than 2,500 rpm or vacuum filtration and then dried in an oven to remove the moisture.
(b) Alternative Methods
   (i) Electrochemical deposition: lithium is deposited onto an electrode under controlled voltage and current in an electrochemical cell.
   (ii) Evaporation: water is evaporated at 100-105° C. under vacuum, leaving behind lithium salt or hydroxide.
   (iii) Adsorption: lithium is adsorbed onto ion-exchange resins or selective adsorbents, followed by desorption and recovery.

The step 16 of adjusting metal ratios of nickel, manganese and cobalt in the precipitated salts of the NMC electrode materials to a target metal ratio for target cathode synthesis to generate a precursor formulation may be accomplished as follows. First, the molar ratios of any critical metal precipitates of nickel, manganese, and cobalt salts, recovered from the pregnant hydrophobic deep eutectic solvent, are measured. This may be accomplished by any means known in the art to be useful for such a purpose, including, for example, by inductively coupled plasma optical emission spectroscopy (ICP-OES) and inductively coupled plasma mass spectroscopy (ICP-MS). The critical metal precipitates are then mixed with any supplemental nickel, manganese, cobalt and lithium raw materials as needed to adjust the final metal ratios to achieve a precise molar ratio matching a target cathode material. For example, the critical metal precipitates may be adjusted by the addition of the necessary raw materials to have a molar ratio of nickel to manganese to cobalt of 1:1:1 for producing an NMC111 electrode/cathode or 5:2:3 for producing an NMC523 electrode/cathode.

During the adjustment, lithium may be added, based on molar ratio of the largest cathode material with a 0.1 to 20 weight percent excess to compensate for potential lithium losses during subsequent calcination. Lithium sources may include the lithium recovered from the lithium-enriched deep eutectic solvent, in accordance with the process previously described, and/or commercially available lithium compounds (e.g. lithium carbonate (Li₂CO₃), lithium hydroxide (LiOH)).

The process 18 of synthesizing the target cathode material from the precursor formulation referenced above, may include subjecting the precursor material to thermal treatment. For example, the precursor formulation may be calcined at 700-900° C., 725-900° C., 750-900° C., 750-850° C. for 8 to 14 hours, 9 to 14 hours, 8-13 hours in air or under controlled oxygen flow. The gas flow may be maintained at 10-40 L/min per kilogram of solid material to ensure appropriate oxidation states of the metals. After calcination, the target cathode material is cooled and then may be ground and optionally sieved to obtain uniform cathode particles.

Following the recovery of the lithium from the lithium-enriched deep eutectic solvent, the treated deep eutectic solvent, now minus the lithium, may be recovered and recycled for future leaching of the next batch of black mass 24. When an anti-solvent, such as ethanol has been used to recover the lithium, the treated deep eutectic solvent may be placed in a vacuum evaporator at 80-105° C. so that the anti-solvent ethanol is vaporized. The vaporized anti-solvent is then condensed and collected, leaving behind the deep eutectic solvent for reuse for black mass leaching. Other processes for separating the anti-solvent ethanol from the deep eutectic solvent include, but are not necessarily limited to, distillation at 80-105° C. or membrane separation using a membrane, of a type known in the art, adapted to separate alcohols from other solvents. This may be done at low temperatures with low energy input.

### EXPERIMENTAL

### Example 1

0.2 g NMC 111 black mass was mixed with 10 g DES. The composition of the DES is thymol, decanoic acid, and ethylene glycol in a 1:1:1 molar ratio. The mixture was heated in an oil bath at 105° C. for 18 hours. After cooling, the mixture was centrifuged at 4000 rmp for 20 minutes to separate the DES leached solution and the remining solids containing graphite, plastics, copper, aluminum, and iron. 4 ml 1M oxalic acid was then added to the DES leached solution to precipitate Ni, Co and Mn as their oxalate salts. After centrifugation at 4000 rpm for 15 minutes, the solid phase, hDES phase and aqueous phase was separated. The solid was washed and dried. 0.21 g of critical metal salts were recovered with recovery rate of Ni 93.3%, Co 80.6%, and Mn 13.9%.

Lithium in hDES phase was recovered by adding ethanol as an antisolvent. Lithium oxalate was precipitated, separated by filtration, washed and dried. 0.11 g lithium oxalate was recovered with a recovery rate of 90.2%.

The critical metal precipitates and Li salt were mixed together with 0.022 g lithium carbonate, 0.0098 g cobalt hydroxide, and 0.053 g manganese hydroxide to reach the desired molar ratio of critical metals for NMC 111 material. The mixture was then blended well with a ball mill (300 rpm for 1 hour) and calcined at 800° C. in air for 12 hours to generate the NMC 111 material. The resultant NMC 111 material is 0.20 g.

### Example 2

0.51 g NMC 111 black mass was mixed with 10 g DES. The composition of the DES is thymol, butyric acid, and glycerol in a 1:1:1 molar ratio. The mixture was heated in an oil bath at 120° C. for 10 hours. After cooling, the mixture was centrifuged at 4000 rmp for 20 minutes to separate the DES leached solution and the remining solids containing graphite, plastics, copper, aluminum, and iron. 15 ml 0.5M oxalic acid was then added to the DES leached solution to precipitate Ni, Co and Mn as their oxalate salts. After centrifugation at 4000 rpm for 15 minutes, the solid phase, hDES phase and aqueous phase was separated. The solid was washed and dried. 0.74 g of critical metal salts were recovered with recovery rate of Ni 95.0%, Co 93.5, and Mn 93.4%.

Lithium in aqueous phase was recovered by evaporation of the solution to less than 4 ml and crystallization in an iced water bath. Lithium oxalate was precipitated, separated by filtration, washed and dried. 0.29 g lithium oxalate was recovered with a recovery rate of 94.2%.

The critical metal precipitates and Li salt were mixed together with 0.046 g lithium carbonate, 0.0079 g cobalt hydroxide, and 0.013 g manganese hydroxide to reach the desired molar ratio of critical metals for NMC 111 material. The mixture was then blended well with a ball mill (300 rpm for 1 hour) and calcined at 800° C. in air for 12 hours to generate the NMC 111 material. The resultant NMC 111 material is 0.51 g.

A number of benefits and advantages are provided by the disclosed method for directly synthesizing nickel-manganese-cobalt (NMC) electrode materials from black mass. Unlike conventional strong acid leaching processes, this method uses environmentally benign and tunable deep eutectic solvent formulations to selectively dissolve lithium and transition metals from black mass with reduced corrosivity and toxicity. The method implements a two-step selective precipitation strategy that first isolates Co/Ni/Mn salts using specific precipitants (e.g., oxalic acid, hydroxides), followed by lithium recovery through either anti-solvent-induced precipitation or carbonate conversion, which allows for high metal selectivity and recovery efficiency. The method incorporates an integrated deep eutectic solvent recovery process via vacuum evaporation, distillation, or membrane separation, allowing for closed-loop operation and minimizing solvent waste. In addition, the recovered metal salts are directly usable, after appropriate blending, for the synthesis of new cathode materials (e.g., NMC, LCO), enabling a direct pathway from recycling to battery material regeneration.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a precipitant”, as used herein, may also refer to, and encompass, a plurality of precipitants.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified. Terms of approximation, such as the terms about, substantially, approximately, etc., as used herein, refers to ±10% of the stated numerical value.

Although the method of this disclosure has been illustratively described and presented by way of specific exemplary embodiments, and examples thereof, it is evident that many alternatives, modifications, or/and variations, thereof, will be apparent to those skilled in the art. For example, other cathode materials (not limit to NMC) may be produced, depending on the composition of the black mass used. Common lithium-ion battery cathode materials include lithium cobalt oxide (LCO), lithium manganese oxide (LMO), and lithium nickel manganese cobalt oxide (NMC). For example, if the black mass originates from LCO, only lithium and cobalt will be leached into hDES, as it contains no nickel or manganese. In such cases, NMC can be synthesized by supplementing with nickel and manganese, or LCO can be directly produced without adding any additional elements.

Accordingly, it is intended that all such alternatives, modifications, or/and variations, fall within the spirit of, and are encompassed by, the broad scope of the appended claims.

What is claimed:

1. A method for synthesizing nickel-manganese-cobalt (NMC) electrode materials from black mass, comprising:
leaching the black mass with a hydrophobic deep eutectic solvent to extract critical metals, including lithium, cobalt, nickel and manganese, and generate a pregnant hydrophobic deep eutectic solvent;
adding a precipitant to the pregnant hydrophobic deep eutectic solvent to precipitate salts of the NMC electrode materials from a lithium-enriched hydrophobic deep eutectic solvent;
adjusting metal ratios of nickel, manganese and cobalt in the precipitated salts of the NMC electrode materials to a target metal ratio for cathode synthesis to generate a precursor formulation; and
synthesizing a target cathode material from the precursor formulation.

2. The method of claim 1, wherein the adjusting of metal ratios includes mixing the precipitated salts with at least one supplemental metal salt material selected from a group consisting of a nickel salt, a manganese salt, a cobalt salt, a lithium salt and combinations thereof to provide the target metal ratio for cathode synthesis.

3. The method of claim 2, wherein the adjusting of metal ratios further includes adding lithium salt to the precipitated salts in a 0.1 to 20 weight percent excess to compensate for potential losses during calcination.

4. The method of claim 3, further including recovering lithium salts from the lithium-enriched hydrophobic deep eutectic solvent and using at least some of the recovered lithium salts during the adjusting of the metal ratios.

5. The method of claim 4, wherein the synthesizing of the target cathode material includes subjecting the precursor formulation to thermal treatment to form the target cathode material.

6. The method of claim 5, wherein thermal treatment includes calcining the precursor formulation.

7. The method of claim 6, wherein the calcining includes heating to a temperature of between 700° C. to 900° C. for 8 to 14 hours in air or under controlled oxygen flow.

8. The method of claim 7, wherein the controlled oxygen flow includes maintaining the oxygen flow at 10-40 L/min per kilogram of precursor formulation.

9. The method of claim 8, including obtaining uniform cathode particles from the target cathode material by performing one or more of the following:
(a) cooling the target cathode material following the thermal treatment;
(b) grounding the target cathode material to a desired particle size; and
(c) sieving the ground cathode material to obtain the uniform cathode particles.

10. The method of claim 4, further including recovering the hydrophobic deep eutectic solvent following the recovering of the lithium salts from the lithium-enriched hydrophobic deep eutectic solvent and recycling the recovered hydrophobic deep eutectic solvent for future leaching of the black mass.

11. The method of claim 1, wherein the synthesizing of the target cathode material includes subjecting the precursor formulation to thermal treatment to form the target cathode material.

12. The method of claim 11, wherein thermal treatment includes calcining the precursor formulation.

13. The method of claim 12, wherein the calcining includes heating to a temperature of between 700° C. to 900° C. for 8 to 14 hours in air or under controlled oxygen flow.

14. The method of claim 13, wherein the controlled oxygen flow includes maintaining the oxygen flow at 10-40 L/min per kilogram of precursor formulation.

15. The method of claim 14, including obtaining uniform cathode particles from the target cathode material by performing one or more of the following:
(a) cooling the target cathode material following the thermal treatment;
(b) grounding the target cathode material to a desired particle size; and
(c) sieving the ground cathode material to obtain the uniform cathode particles.

16. The method of claim 1, wherein the leaching of the black mass includes mixing the hydrophobic deep eutectic solvent with the black mass at a mass ratio of hydrophobic deep eutectic solvent to black mass of from 5:1 to 50:1 to create a hydrophobic deep eutectic solvent and black mass mixture.

17. The method of claim 16, wherein the leaching of the black mass includes heating the hydrophobic deep eutectic solvent and black mass mixture to a temperature of between 80° C. and 140° C. for 2 to 24 hours with continuous or intermittent stirring.

18. The method of claim 1, further including selecting the precipitant from a group of materials consisting of oxalic acid, oxalic salts, sodium oxalate, potassium oxalate, ammonium oxalate, sodium hydroxide, ammonium hydroxide, potassium hydroxide and combinations thereof.

19. The method of claim 18, further including providing a precipitant solution at a volume ratio of pregnant hydrophobic deep eutectic solvent to precipitant solution of between 0.1:1 and 10:1.

20. A method for synthesizing nickel-manganese-cobalt (NMC) electrode materials from black mass, comprising:
leaching the black mass with a leaching agent to extract critical metals, including lithium, cobalt, nickel and manganese, and generate a pregnant leaching agent;
adding a precipitant to the pregnant leaching agent to precipitate salts of the NMC electrode materials from a lithium-enriched leaching agent;
adjusting metal ratios of nickel, manganese and cobalt in the precipitated salts of the NMC electrode materials to a target metal ratio for cathode synthesis to generate a precursor formulation; and
synthesizing a target cathode material from the precursor formulation.

21. A method for synthesizing electrode materials from black mass, comprising:
leaching the black mass with a hydrophobic deep eutectic solvent to extract critical metals for electrode construction and generate a pregnant hydrophobic deep eutectic solvent;
adding a precipitant to the pregnant hydrophobic deep eutectic solvent to precipitate salts of the electrode materials from a lithium-enriched hydrophobic deep eutectic solvent;
adjusting metal ratios in the precipitated salts of the electrode materials to a target metal ratio for cathode synthesis to generate a precursor formulation; and
synthesizing a target cathode material from the precursor formulation.
